(19) United States
(12) Patent Application Publication
(10) Pub. No.: US 2024/0202586 A1
(43) Pub. Date: Jun. 20, 2024

(54) Automated Outlier Removal for Multivariate Modeling

(71) Applicant: AMGEN INC., Thousand Oaks, CA (US)

(72) Inventors: Christopher J. Garvin, Kingston, RI (US); Phong Nguyen, Manassas, VA (US); Sean M. Rumberger, Belfair, WA (US)

(21) Appl. No.: 18/286,702

(22) PCT Filed: Apr. 6, 2022
(86) PCT No.: PCT/US22/23607

§ 371 Date: Oct. 12, 2023

Related U.S. Application Data
(60) Provisional application No. 63/174,805, filed on Apr. 14, 2021.

(51) Int. Cl. G06N 20/00

(52) U.S. Cl. CPC G06N 20/00

(57) ABSTRACT

In a method for improving multivariate model performance, a first data set comprising values of a plurality of features and corresponding labels is obtained. A second data set is generated from the first data set. Generating the first data set includes generating an intermediate data set by removing a first set of outliers from the first data set using a univariate statistical technique, generating a first multivariate model using the intermediate data set, and removing a second set of outliers from the first data set using the first multivariate model and a multivariate statistical technique. A second multivariate model is generated using the second data set.

### FIELD OF DISCLOSURE

The present application generally relates to multivariate modeling, and more specifically relates to techniques for automatically removing outliers from historical data used to train a multivariate model.

### BACKGROUND

Multivariate modeling is a statistical technique that uses dimensionality reduction to distill multiple variables into summary statistics that efficiently describe a modeling target. Multivariate models can be used for many purposes in pharmaceutical and other industries. For example, such models can be used to detect weak signals in a process, to quickly identify the root cause of a problem, to predict a particular outcome (e.g., a product quality metric), and so on. Currently available multivariate modeling tools include SIMCA® and SIMCA®-online, which are off-the-shelf software applications with multivariate modeling and monitoring capabilities, respectively. With these tools, a user typically builds models from representative historical data. For example, the historical data may include sensor readings from manufacturing equipment, parameters or descriptors of materials used for manufacturing, variables derived from such readings and/or parameters, and so on. However, some historical data can degrade model performance. In particular, historical data of this sort usually includes outliers resulting from factors such as process or equipment issues, erroneous data, and/or noisy signals. To ensure that a multivariate model is representative and robust, a user can manually remove outliers using a variety of statistical measures as an approximate guide. While tools such as SIMCA® can provide such measures, the outlier removal process is manual, time-consuming, and non-standardized. Thus, conventional processes for generating multivariate models can be slow and costly, and/or result in inconsistent and/or degraded model performance.

### SUMMARY

Embodiments described herein relate to systems and methods for creating inferential or predictive multivariate models, for pharmaceutical or other fields or industries. For example, the systems and methods disclosed herein may be used to create a multivariate model that analyzes/monitors real-time process data, and infers whether there is a problem with the process (e.g., faulty sensors or other equipment failure). As another example, the systems and methods disclosed herein may be used to create a multivariate model that analyzes sets of process and material parameters being considered for use, and predicts the outcome of that process when using those materials. The multivariate model may be a partial least squares (PLS) model, a neural network, or any other sort of multivariate, machine learning model (or combination of models) capable of inferring and/or predicting information (e.g., inferring or predicting a particular value or classification).

More specifically, the systems and methods disclosed herein automatically detect and remove outliers from historical data that is used to build/train a multivariate model, using both univariate and multivariate statistical techniques. For a given parameter to be used as a model input/feature, for example, an application (or application add-in, etc.) may determine an interquartile range for that parameter within a set of historical data, and filter out all observations falling outside that interquartile range. The application can then build an “intermediate” multivariate model (e.g., a PLS model) based on the filtered historical data, and generate multivariate statistics for the historical data values using the intermediate model. For example, the application may calculate Hotellings T² and DModX values for each of the historical data values. The application may then filter out additional observations based on those multivariate statistics and predetermined thresholds. After this second round of outlier filtering, the remaining historical data values may be used (by the same application or another application) to train a “final” multivariate model. The final model may be of the same type as the intermediate model (e.g., another PLS model), or may be a different type of model (e.g., a deep neural network) or set of models.

Using these systems and methods, multivariate models can exhibit more consistent (from model to model) and/or improved performance, and/or can be generated more quickly than was possible with conventional techniques.

### BRIEF DESCRIPTION OF THE DRAWINGS

The skilled artisan will understand that the figures, described herein, are included for purposes of illustration and do not limit the present disclosure. The drawings are not necessarily to scale, and emphasis is instead placed upon illustrating the principles of the present disclosure. It is to be understood that, in some instances, various aspects of the described implementations may be shown exaggerated or enlarged to facilitate an understanding of the described implementations. In the drawings, like reference characters throughout the various drawings generally refer to functionally similar and/or structurally similar components.

FIG. 1 is a simplified block diagram of an example system that may be used to implement the techniques described herein.

FIG. 2 is a flow diagram of an example process for creating a multivariate model based on filtered historical data, which may be implemented at least in part by the system of FIG. 1.

FIG. 3 depicts an example univariate statistic (interquartile range) that the univariate analyzer of FIG. 1 may use to remove historical data outliers.

FIGS. 4A and 4B depict example multivariate statistics (Hotellings T² and DModX, respectively) that the multivariate analyzer of FIG. 1 may use to remove historical data outliers.

FIG. 5 is a flow diagram of an example method for improving multivariate model performance.

### DETAILED DESCRIPTION

The various concepts introduced above and discussed in greater detail below may be implemented in any of numerous ways, and the described concepts are not limited to any particular manner of implementation. Examples of implementations are provided for illustrative purposes.

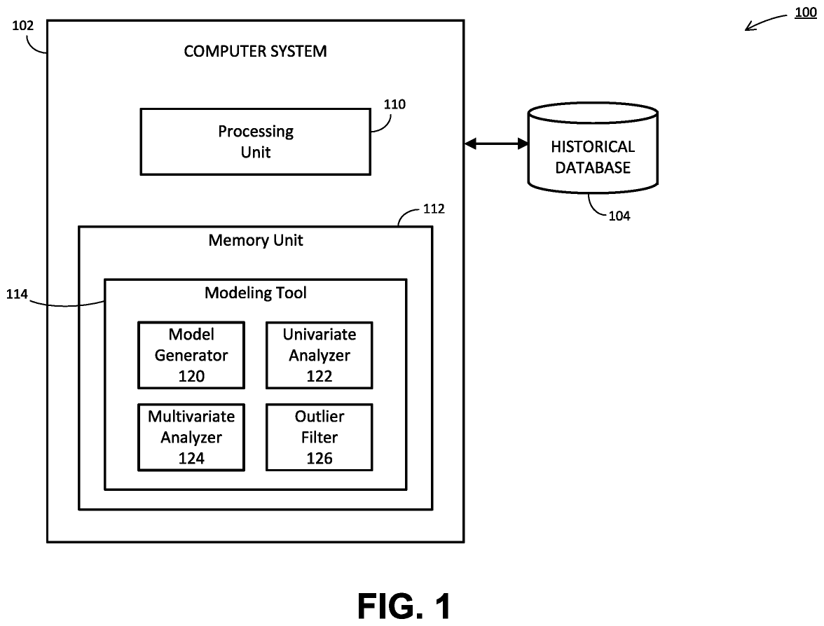

FIG. 1 is a simplified block diagram of an example system 100 that implements the techniques described herein, according to one embodiment. The system 100 includes a computer system 102 communicatively coupled to a historical database 104. Generally, the computer system 102 is configured to create/build/train one or more multivariate, machine learning models using data in the historical database 104. The computer system 102 may be a general-purpose computer that is specifically programmed to perform the operations discussed herein, or a special-purpose computing device. As seen in FIG. 1, the computer system 102 includes a processing unit 110 and a memory unit 112. In some embodiments, however, the computer system 102 includes two or more computers that are either co-located or remote from each other. In these distributed embodiments, the operations described herein relating to the processing unit 110 and the memory unit 112, or relating to any of the modules implemented when the processing unit 110 executes instructions stored in the memory unit 112, may be divided among multiple processing units and/or multiple memory units.

The processing unit 110 includes one or more processors, each of which may be a programmable microprocessor that executes software instructions stored in the memory unit 112 to execute some or all of the functions of the computer system 102 as described herein. The processing unit 110 may include one or more graphics processing units (GPUs) and/or one or more central processing units (CPUs), for example. Alternatively, or in addition, one or more processors in the processing unit 110 may be other types of processors (e.g., application-specific integrated circuits (ASICs), field-programmable gate arrays (FPGAs), etc.), in which case some of the functionality of the computer system 102 described herein may be at least partially implemented in hardware.

The memory unit 112 may include one or more volatile and/or non-volatile memories. Any suitable memory type or types may be included in the memory unit 112, such as a read-only memory (ROM) and/or a random access memory (RAM), a flash memory, a solid-state drive (SSD), a hard disk drive (HDD), and so on. Collectively, the memory unit 112 may store the instructions of one or more software applications, the data received/used by those applications, and the data output/generated by those applications.

In particular, the memory unit 112 stores the software instructions of various modules that, when executed by the processing unit 110, perform various functions for the purpose of creating one or more multivariate models. Specifically, in the example embodiment of FIG. 1, the memory unit 112 includes a modeling tool 114, which is an application (or set of applications) comprising a model generator 120, a univariate analyzer 122, a multivariate analyzer 124, and an outlier filter 126. In alternative embodiments, the modeling tool 114 includes one or more additional modules not shown in FIG. 1. As noted above, the computer system 102 may be a distributed system, in which case one, some, or all of the modules 120, 122, 124, and 126 may be implemented in whole or in part by different computing devices or systems (e.g., by a computers of the computer system 102 that are coupled to each other via one or more wired and/or wireless communication networks). Moreover, the functionality of any one of the modules 120, 122, 124, and 126 may be divided among different software applications and/or application components. As just one example, the modeling tool 114 may be a modeling application/tool such as SIMCA® or SIMCA®-online, with the model generator 120 being a core function of the modeling tool 114 and the outlier filter 126 being an add-in to the modeling tool 114 (e.g., Python code), and with the univariate analyzer 122 and/or the multivariate analyzer 124 optionally being integral parts of that modeling application/tool or parts of the add-in, depending on the embodiment.

The model generator 120 uses select data from the historical database 104 when creating/building/training “intermediate” multivariate models to support filtering of outliers via multivariate statistical techniques (as discussed in more detail below), and when creating/building/training “final” multivariate models (e.g., for use in production, development, etc.). It is understood that a model referred to herein as “final” may still be subject to further modification, such as by additional training (e.g., periodic refinements of the model during run-time use, or further refinement before run-time use begins). The intermediate and final multivariate models may be of the same type (e.g., both PLS models), or may be of different types (e.g., a PLS model and a deep neural network, respectively). As discussed in further detail below, the univariate analyzer 122, the multivariate analyzer 124, and the outlier filter 126 operate in tandem to remove outliers from a data set in the historical database 104, before the model generator 120 uses the filtered data set to build a final model.

The historical database 104 may be stored in the memory unit 112, and/or in another local or remote memory (e.g., a memory coupled to a remote library server, etc.). Generally, the historical database 104 may include past observations representing virtually any type(s) of information, depending on the type and purpose of the multivariate model(s) to be trained. In some embodiments, for example, the historical database 104 may include observations corresponding to numerical values of parameters (e.g., sensor readings such as temperature, pressure, viscosity, pH, chromatography measurements, flow rate, voltage, current, etc.) and/or categorical values (e.g., whether a certain characteristic is present, whether a certain event has been detected, particle or molecule type, etc.), and/or derived values such as the rate of change in a sensed parameter, or a count of how many times a sensed event was detected, etc.

In some embodiments, the modeling tool 114 or another application stored in the memory unit 112 executes (e.g., during run-time) the models generated by the model generator 120. Alternatively, the models generated by the model generator 120 may be implemented by a different computing system or device (e.g., after the other system or device downloads the model(s) from the computer system 102 via a network).

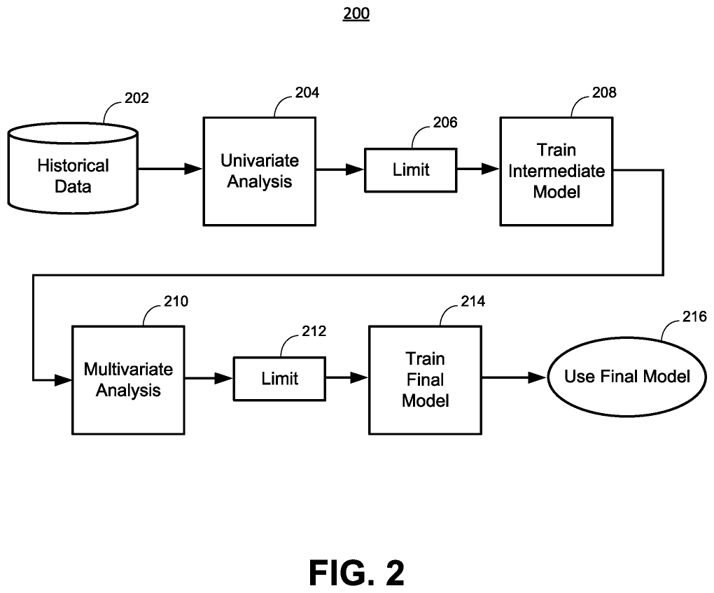

Example operation of the system 100 of FIG. 1 is now discussed with reference to the example process 200 shown in FIG. 2. While the example process 200 is described with reference to components of the example system 100, the process 200 can instead be implemented by another suitable system.

In the process 200, the univariate analyzer 122 analyzes historical data 202 (e.g., data values stored in the historical database 104) using a univariate statistical technique at stage 204, and the outlier filter 126 removes observations based on that analysis at stage 206. That is, the univariate analyzer 122 analyzes the values of each feature represented in the historical data 202 (e.g., in a relatively simple example, the features of temperature and pressure) independently of the values of any other feature(s) represented in the historical data 202. For example, the univariate analyzer 122 may determine, for each feature represented by the historical data 202, percentile values for each corresponding value within the historical data 202 (as compared to the full set of values within the historical data 202 for that feature), after which the outlier filter 126 removes all observations corresponding to values that fall outside a particular percentile limit. In one such embodiment, the outlier filter 126 removes all observations corresponding to values that fall outside an interquartile range (i.e., all values outside the range between the 25^{th} and 75^{th} percentiles). Other percentile ranges are also possible (e.g., outside the 10^{th} to 90^{th} percentile, or outside the 20^{th} to 80^{th} percentile, etc.).

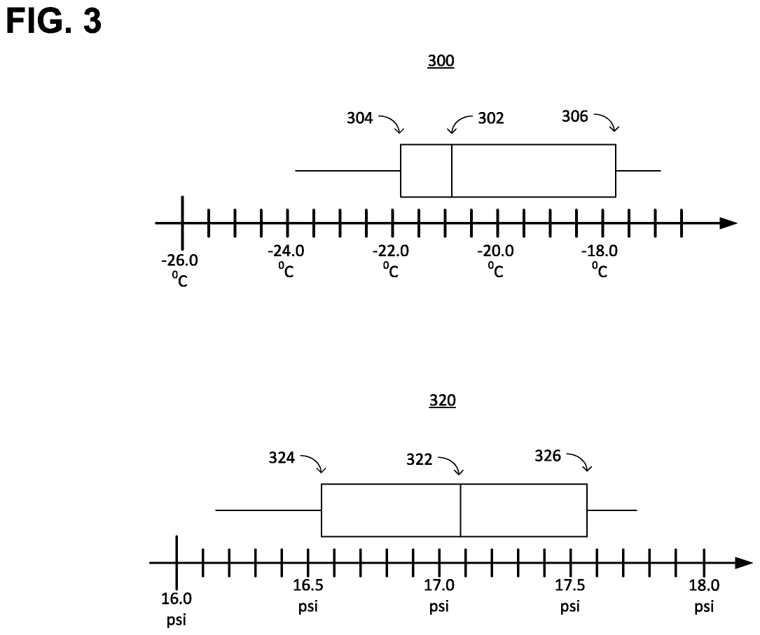

Example interquartile ranges are depicted in plots 300 and 320 of FIG. 3 for temperature and pressure values, respectively. In the example temperature plot 300, the median 302 falls at approximately −20.9° C., while the 25^{th} percentile value 304 and 75^{th} percentile value 306 fall at approximately −21.8° C. and −17.7° C., respectively. In the example pressure plot 320, the median 322 falls at approximately 17.08 psi while the 25^{th} percentile value 324 and 75^{th} percentile value 326 fall at approximately 16.55 psi and 17.56 psi, respectively. Thus, when forming a training data set for an intermediate model from the historical data 202 in this example, the outlier filter 126 would remove from the historical data 202 all observations with temperatures lower than −21.8° C. or higher than −17.7° C., and all observations with pressures lower than 16.55 psi or higher than 17.56 psi.

In other embodiments, the univariate analyzer 122 uses a different univariate statistical technique at stage 204 before the outlier filter 126 removes outliers at stage 206. For example, the univariate analyzer 122 may calculate at stage 204 a mean value and a standard deviation from the mean for the complete set of values corresponding to a single feature, after which the outlier filter 126 at stage 206 removes all observations corresponding to values for that feature that are more than three standard deviations (or more than two standard deviations, more than four standard deviations, etc.) above or below the calculated mean.

At stage 208 of the process 200, the model generator 120 trains an intermediate multivariate model using the historical data 202 (including corresponding labels), without the outliers that were removed at stage 206. Each label reflects the parameter or classification that the intermediate model is intended to infer or predict, and may be associated with a particular value of each feature. In an example where model features include temperature and pressure, for instance, each label (e.g., a particular error classification, or a particular yield percentage, etc.) may be associated with a single temperature and a single pressure.

In some embodiments, the intermediate model is a partial least squares (PLS) model. Alternatively, the model generator 120 may train another suitable type of multivariate model (e.g., an additive tree model, multidimensional scaling model, cluster analysis model, etc.), so long as the model permits the calculation of one or more metrics indicative of the degree to which any particular input or combination of inputs was an outlier.

At stage 210, the multivariate analyzer 124 performs a multivariate statistical technique using the intermediate model and the inputs to that model (i.e., the historical data 202 minus the outliers removed at stage 206), and the outlier filter 126 removes values based on that analysis at stage 212. That is, unlike the univariate analysis of stage 204, the analysis at stage 210 considers the values in the historical data 202 concurrently across multiple features represented in the historical data 202. For example, the multivariate analyzer 124 may determine, for each feature represented in the historical data 202, Hotellings T² and DModX values for each corresponding observation that remains (after stage 206) within the filtered historical data 202. The Hotellings T² statistic generally indicates whether an input or combination of inputs is an extreme outlier, while DModX generally indicates how well an input or combination of inputs fits the model. Next, at stage 212, the outlier filter 126 removes all observations corresponding to values that fall outside one or more particular limits. For example, the outlier filter 126 may remove all observations of the Hotellings T² statistic that are outside of a particular confidence threshold (e.g., 95%), and/or all observations with a DModX value above a predetermined threshold.

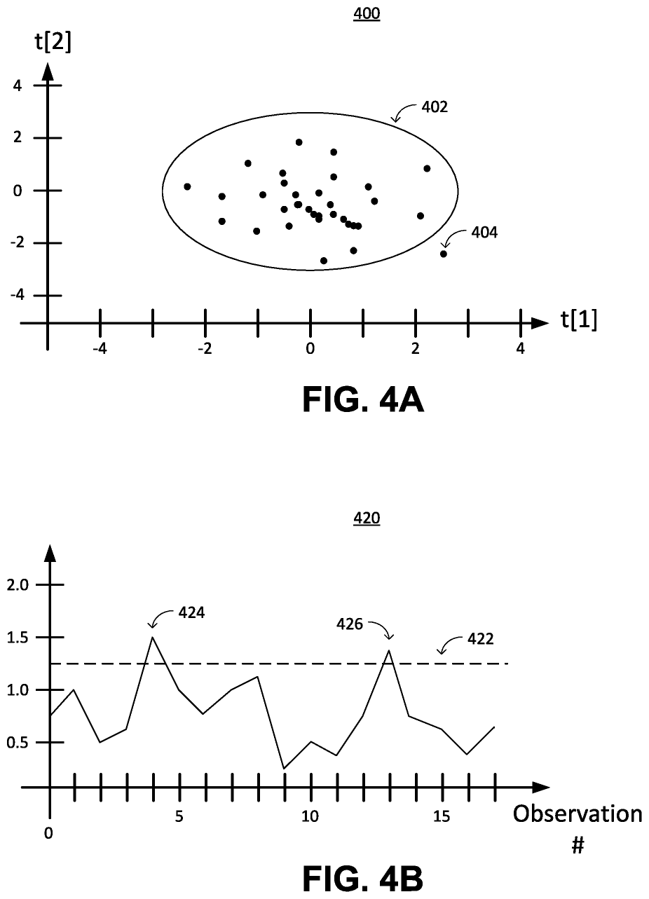

Example Hotellings T² statistics are depicted in plot 400 of FIG. 4A, while example DModX values are depicted in plot 420 of FIG. 4B. In the plot 400, the ellipse 402 corresponds to a particular, predetermined confidence threshold (e.g., 95%, or 99%, etc.). As seen in this example, only value 404 falls outside the ellipse 402. In the plot 420, a predetermined threshold 422 corresponds to a particular DModX value. As seen in this example, only values 424 and 426 exceed the threshold 422. Thus, at stage 212 in the example of FIGS. 4A and 4B, the outlier filter 126 would remove the observations corresponding to the values 404, 424, and 426 from the remaining historical data 202. In other embodiments, the multivariate analyzer 124 use a different multivariate statistical technique to remove outliers at stage 210 before the outlier filter 126 removes outliers at stage 212.

At stage 214, the model generator 120 trains a final multivariate model using the historical data 202 (including corresponding labels), minus the outliers that were removed at stages 206 and 212. In some embodiments, the final model is of the same type as the intermediate model (e.g., both PLS models). In other embodiments, the intermediate and final models are of different types. For example, the intermediate model may be a PLS model and the final model may be a deep neural network. In some embodiments, the intermediate and final models are trained by different applications, devices, and/or systems. For example, the model generator 120 may train the intermediate model at stage 208, after which the computer system 102 provides the double-filtered historical data 202 (after stage 212) to another computer system that trains the final model. At stage 216, the final, trained model is used for its intended purpose (e.g., for research or development purposes, for real-time monitoring during production, etc.). Stage 216 may be performed by the computer system 102 (e.g., the modeling tool 114 or another application stored in the memory unit 112), or by another suitable computer system.

In some embodiments, stages 210, 212, and 214 can occur more than once, in an iterative manner. For example, a user may enter a desired number of iterations, and the multivariate analyzer 124 and the outlier filter 126 may remove the observations corresponding to additional outlier values during each iteration. More generally, in some embodiments, a user may interact with a user interface (e.g., input and output hardware/firmware/software of the computer system 102, or of a client device external to the computer system 102, etc.) to control one or more parameters associated with the process 200. For example, the user may select a specific data set for use as historical data 202, enter or select the limits to be applied at stages 206 and 212, enter or select specific model hyperparameters, and so on. The user interface may be generated by the modeling tool 114 for presentation on a display device, for example.

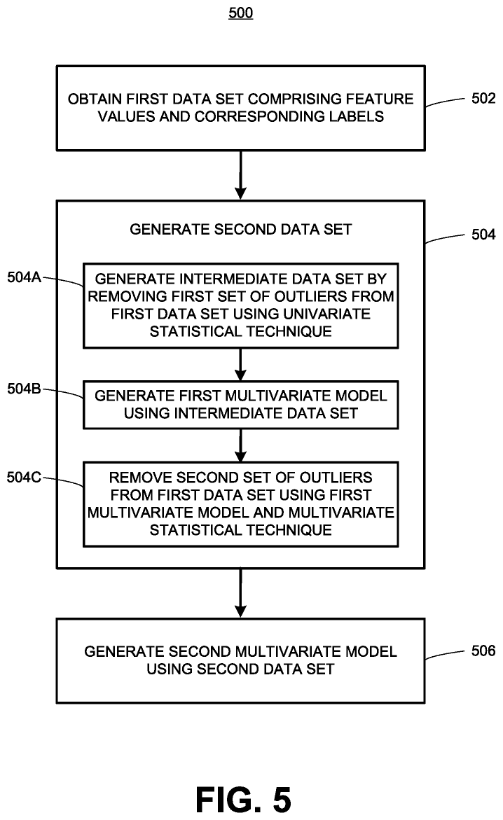

FIG. 5 is a flow diagram of an example method 500 for improving multivariate model performance. The method 500 may be implemented, in part or in its entirety, by the processing unit 110 of the computer system 102 when executing the software instructions of the modeling tool 114 stored in the memory unit 112, for example.

At block 502, a first data set is obtained. The first data set (e.g., the historical data 202) comprises values of a plurality of features, and corresponding labels. Each label reflects the parameter or classification that a first multivariate model (discussed below with reference to sub-block 504B) is intended to infer or predict. Moreover, each label is associated with a respective set of multiple values in the first data set, with each of those multiple values corresponding to a respective feature that is to be used as an input to the first multivariate model. Block 502 may include directly accessing a database (e.g., the historical database 104), loading a file from a storage unit, or downloading (e.g., requesting and receiving) the first data set from a remote server hosting a database, for example.

At block 504, a second data set is generated. Block 504 includes sub-blocks 504A, 504B, and 504C. At sub-block 504A, an intermediate data set is generated by removing a first set of outliers from the first data set using a univariate statistical technique. For example, sub-block 504A may include, for each feature of the plurality of features, removing from the first data set observations corresponding to values that fall outside a predetermined percentile range (e.g., values that fall outside an interquartile range). At sub-block 504B, the first multivariate model is generated using the intermediate data set as training data. The first multivariate model may be a PLS model, for example, or any other suitable type of multivariate model. At sub-block 504C, a second set of outliers is removed from the first data set using the first multivariate model that was generated at sub-block 504B and a multivariate statistical technique. For example, sub-block 504C may include generating Hotelling's T² statistics for the model inputs/values and removing particular observations based on those Hotelling's T² statistics, and/or calculating DModX values for the model inputs/values and removing particular observations based on those DModX values.

It is understood that the removal of outliers at sub-blocks 504A and 504C may occur in various different ways. For example, the method 500 may include generating a first multivariate model training set (at sub-block 504A) that excludes the first set of outliers, and then generating a second multivariate model training set (at sub-block 504C) by copying the first multivariate model training set and then removing the second set of outliers from the copied training set. As another example, the method 500 may include generating a first multivariate model training set (at sub-block 504A) that excludes the first set of outliers, and then generating a second multivariate model training set (at sub-block 504C) by copying the entire first data set and then removing both the first and the second set of outliers from the copied first data set.

At block 506, a second multivariate model is generated using the second data set that was generated at block 504. The second multivariate model may be the same type of model as the first multivariate model (e.g., both PLS models), such that the second multivariate model is an updated/retrained version of the first multivariate model. Alternatively, the second multivariate model may be a different type of model than the first multivariate model. For example, the first multivariate model may be a PLS model, and the second multivariate model may be a deep neural network. Depending on the embodiment, the second data set may be the data set produced by sub-block 504C, or may result from one or more additional filtering/processing steps occurring after sub-block 504C. More generally, block 504 may include one or more additional filtering/processing sub-blocks that occur before, after, between, and/or during sub-blocks 504A and 504C.

In some embodiments, the method 500 includes one or more additional blocks not shown in FIG. 5. For example, the method 500 may include an additional block, occurring after block 506, in which a value or classification is inferred using the trained second multivariate model, in which a value or classification is predicted using the trained second multivariate model, and/or in which a process is monitored (e.g., substantially in real-time) using the second multivariate model. As another example, the method 500 may include one or more additional blocks, occurring before block 502, in which a user interface is generated and/or presented to a user via a display device, and in which one or more user entries are received via the user interface (e.g., a user indication of which data set to use as the first data set, which limits to apply at sub-blocks 504A and/or 504C, etc.).

Although the systems, methods, devices, and components thereof, have been described in terms of example embodiments, they are not limited thereto. The detailed description is to be construed as exemplary only and does not describe every possible embodiment of the invention, because describing every possible embodiment would be impractical if not impossible. Numerous alternative embodiments could be implemented, using either current or future technology, that would still fall within the scope of the claims defining the invention.

Those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

1. A method for improving multivariate model performance, the method comprising:
obtaining, by one or more processors, a first data set comprising (i) values of a plurality of features and (ii) corresponding labels;
generating, by the one or more processors, a second data set from the first data set, at least by
generating an intermediate data set by removing a first set of outliers from the first data set using a univariate statistical technique,
generating a first multivariate model using the intermediate data set, and
removing a second set of outliers from the first data set using the first multivariate model and a multivariate statistical technique; and
generating, by the one or more processors, a second multivariate model using the second data set.

2. The method of claim 1, wherein removing the first set of outliers includes, for each feature of the plurality of features, removing observations corresponding to values outside a predetermined percentile range.

3. The method of claim 2, wherein the predetermined percentile range is an interquartile range.

4. The method of claim 1, wherein removing the second set of outliers includes generating Hotelling's T² statistics and removing observations based on the Hotelling's T² statistics.

5. The method of claim 1, wherein removing the second set of outliers includes calculating DModX values and removing observations based on the DModX values.

6. The method of claim 1, wherein the first multivariate model is a partial least squares model.

7. The method of claim 6, wherein the second multivariate model is an updated version of the partial least squares model.

8. The method of claim 1, wherein obtaining the first data set includes accessing a database storing historical data.

9. The method of claim 1, further comprising:
monitoring a process substantially in real-time using the second multivariate model.

10. The method of claim 1, further comprising:
inferring a value or classification using the second multivariate model.

11. The method of claim 1, further comprising:
predicting a value or classification using the second multivariate model.

12. One or more non-transitory, computer-readable media storing instructions that, when executed by processing hardware of a computer system, cause the computer system to:
obtain a first data set comprising (i) values of a plurality of features and (ii) corresponding labels;
generate a second data set from the first data set, at least by
generating an intermediate data set by removing a first set of outliers from the first data set using a univariate statistical technique,
generating a first multivariate model using the intermediate data set, and
removing a second set of outliers from the first data set using the first multivariate model and a multivariate statistical technique; and
generate a second multivariate model using the second data set.

13. The one or more non-transitory, computer-readable media of claim 12, wherein removing the first set of outliers includes, for each feature of the plurality of features, removing observations corresponding to values outside a predetermined percentile range.

14. The one or more non-transitory, computer-readable media of claim 13, wherein the predetermined percentile range is an interquartile range.

15. The one or more non-transitory, computer-readable media of claim 12, wherein removing the second set of outliers includes generating Hotelling's T² statistics and removing observations based on the Hotelling's T² statistics.

16. The one or more non-transitory, computer-readable media of claim 12, wherein removing the second set of outliers includes calculating DModX values and removing observations based on the DModX values.

17. The one or more non-transitory, computer-readable media of claim 12, wherein the first multivariate model is a partial least squares model.

18. The one or more non-transitory, computer-readable media of claim 17, wherein the second multivariate model is an updated version of the partial least squares model.

19. The one or more non-transitory, computer-readable media of claim 12, wherein the instructions further cause the computer system to:
monitor a process substantially in real-time using the second multivariate model.

20. The one or more non-transitory, computer-readable media of claim 12, wherein the instructions further cause the computer system to:
infer or predict a value or classification using the second multivariate model.
